(19) United States
(12) Patent Application Publication
(10) Pub. No.: US 2020/0158436 A1
(43) Pub. Date: May 21, 2020

(54) VERTICAL KILN

(71) Applicant: Michael James Glotfelty, Lakeland, FL (US)

(72) Inventor: Michael James Glotfelty, Lakeland, FL (US)

(21) Appl. No.: 16/444,994

(22) Filed: Jun. 18, 2019

Related U.S. Application Data
(60) Provisional application No. 62/763,467, filed on Jun. 18, 2018.

(51) Int. Cl. F27D 5/00; F27D 1/18

(52) U.S. Cl. CPC F27D 5/005; F27D 2005/0081; F27D 1/18

(57) ABSTRACT

A top-loading vertical kiln, a front-loading vertical kiln, and a vertical kiln retrofit kit are described. Each include a baffle having a central aperture and a plurality of rods spaced apart from each other and configured to rest in corresponding detents in a top surface of the baffle, wherein the detents include pairs of detents with a first detent of a pair being formed on a first side of the aperture and a second detent of the pair being formed on a second side of the aperture opposite the first side.

### RELATED APPLICATIONS

This application claims the benefit of U.S. Application No. 62/763,467, entitled “Knife or Blade Vertical Hanging System for Heat Treating,” filed on Jun. 18, 2018, which is incorporated herein by reference in its entirety.

### TECHNICAL FIELD

Some implementations relate generally to kilns, and more particularly, to vertical kilns, systems, and accessories.

### BACKGROUND

High temperature ovens or kilns are often used to heat treat knives, swords or other blades to high temperatures (e.g., of up to 2200 degrees Fahrenheit) to de-stress forged metal such as steel, to harden or temper the forged metal, to soften the forged metal, to prepare the forged metal to receive a ground edge, or to be further shaped or drilled after forging.

After forging a blade, heat treating may be required to sharpen an edge of the blade, drill the blade to attach a handle, or shape on a grinder.

Most conventional ovens or kilns are horizontal in nature such that blades are typically set in a tray on their spines during a heat treatment process within the oven or kiln. As heat is applied to the blades, the blades may become red hot and relatively soft. The red hot blades may be susceptible to bending or warping in a horizontal kiln while resting on their spines in the tray.

When removed from the oven or kiln, the blades may be transitioned from a horizontal position to a vertical position. This transition can cause bending or warping as blades may be removed at or near a peak temperature and may be at their softest state. Blades that bend or warp may need to be straightened on an anvil with a rounding hammer, for example.

Some blade forming processes may require the blades to undergo heat treatment in several cycles, which includes being placed into and taken out of the oven or kiln several times to perform a desired heat treatment process. After each heat treatment cycle, the blades may need to be checked for bending or warping and if any bending or warping is present, may need to be straightened.

Some implementations were conceived in light of the above mentioned problems or limitations, among other things.

### SUMMARY

Some implementations can include a top-loading vertical kiln comprising a body portion having a lid disposed on a top side of the body, wherein the lid is configured to be opened to insert items into the kiln and closed during a heat treating operation being performed in the kiln, and a baffle having a central aperture and a plurality of rods spaced apart from each other and configured to rest in corresponding detents in a top surface of the baffle, wherein the detents include pairs of detents with a first detent of a pair being formed on a first side of the aperture and a second detent of the pair being formed on a second side of the aperture opposite the first side.

Some implementations further comprise a blade suspension element configured to suspend a blade between a respective pair of rods by resting across a top of the respective pair of rods. In some implementations, the blade suspension element can include a rod configured to be inserted through an aperture in the blade, and the rod can include an alloy rod.

In some implementations, the blade suspension element can include a coil configured to mechanically engage the blade through an interference fit.

In some implementations, the baffle is removable and is configured to be supported within the kiln by a plurality of legs extending in a downward direction from the baffle opposite the top surface. In some implementations, the rods include ceramic rods.

Some implementations can include a front-loading vertical kiln comprising a body portion having a lid disposed on a side of the body, wherein the lid is configured to be opened to insert items into the kiln and closed during a heat treating operation being performed in the kiln and a baffle having a central aperture and a plurality of rods spaced apart from each other and configured to rest in corresponding detents in a top surface of the baffle, wherein the detents include pairs of detents with a first detent of a pair being formed on a first side of the aperture and a second detent of the pair being formed on a second side of the aperture opposite the first side.

Some implementations can further include a blade suspension element configured to suspend a blade between a respective pair of rods by resting across a top of the respective pair of rods. In some implementations, the blade suspension element is a rod configured to be inserted through an aperture in the blade. In some implementations, the rod includes an alloy rod.

In some implementations, the blade suspension element is a coil configured to mechanically engage the blade through an interference fit. In some implementations, the baffle is removable and is configured to be supported within the kiln by a plurality of legs extending in a downward direction from the baffle opposite the top surface. In some implementations, the rods include ceramic rods.

Some implementations can include a vertical hanging system kiln retrofit kit comprising a baffle having a central aperture and a plurality of rods spaced apart from each other and configured to rest in corresponding detents in a top surface of the baffle, wherein the detents include pairs of detents with a first detent of a pair being formed on a first side of the aperture and a second detent of the pair being formed on a second side of the aperture opposite the first side.

Some implementations can further include a blade suspension element configured to suspend a blade between a respective pair of rods by resting across a top of the respective pair of rods. In some implementations, the blade suspension element is a rod configured to be inserted through an aperture in the blade.

In some implementations, the rod includes an alloy rod. In some implementations, the blade suspension element is a coil configured to mechanically engage the blade through an interference fit. In some implementations, the baffle is removable and is configured to be supported within the kiln by a plurality of legs extending in a downward direction from the baffle opposite the top surface of the baffle.

### BRIEF DESCRIPTION OF THE DRAWINGS

FIG. 1 is a diagram of an example baffle for a vertical kiln or vertical kiln retrofit kit in accordance with some implementations.

FIG. 2 is a diagram of an example baffle with support legs for a vertical kiln or vertical kiln retrofit kit in accordance with some implementations.

FIG. 3 is a diagram of an example vertical kiln in accordance with some implementations.

FIG. 4 is a top view of an example front loading vertical kiln in accordance with some implementations.

FIG. 5 is a front view of an example front loading vertical kiln in accordance with some implementations.

FIG. 6 is a front view of an example front loading vertical kiln with removable baffle in accordance with some implementations.

FIG. 7 is a side view of an example front loading vertical kiln in accordance with some implementations.

FIG. 8 is a side view of an example top loading vertical kiln in accordance with some implementations.

FIG. 9 is a side view of an example top loading vertical kiln in accordance with some implementations.

FIGS. 10A and 10B show an example top loading tabletop vertical kiln in accordance with some implementations.

### DETAILED DESCRIPTION

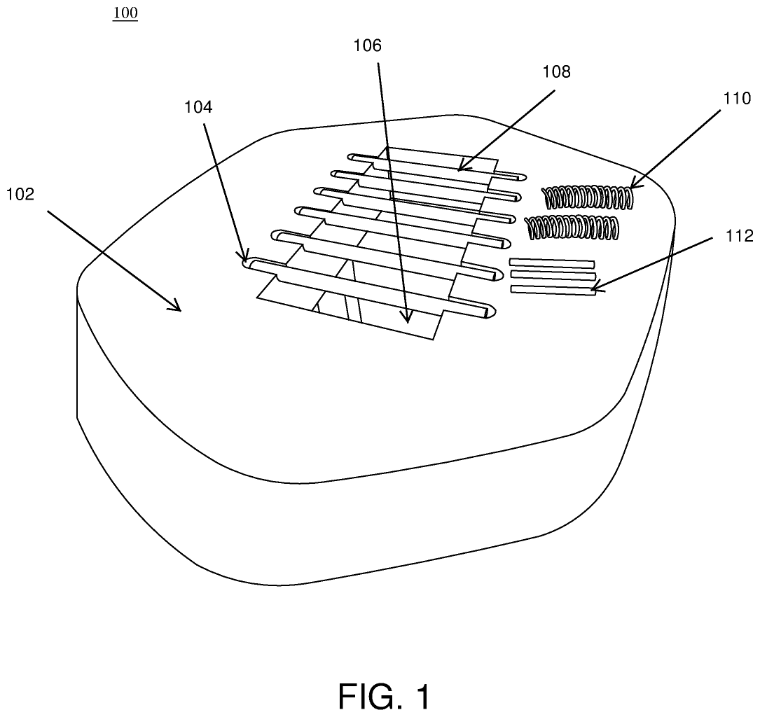

FIG. 1 is a diagram of an example baffle system 100 for a vertical kiln or vertical kiln retrofit kit in accordance with some implementations The system can include a refractory baffle 102 having one or more pairs of detents 104 each recess configured to receive an end of a rod 108 (e.g., a ceramic rod) that spans a central aperture 106 of the baffle 102. The system can further include one or more pins 112 or coil members 110 that can be used to suspend an object (e.g., a blade) vertically within the kiln. In some implementations, the baffle can be about 16 inches from flat side to flat side and about 2.5 inches thick. The ceramic rods 108 can be about 6 inches long and about ¾ inches in diameter. Any dimensions mentioned herein are by way of example and illustration and are not intended to be limiting.

In addition or as an alternative to the central aperture 106, a baffle 102 can include one or more slots that can receive a blade and suspend the blade without reliance on a pair of ceramic rod (e.g., a pin or coil can engage the baffle adjacent to the slot that a blade is passing through).

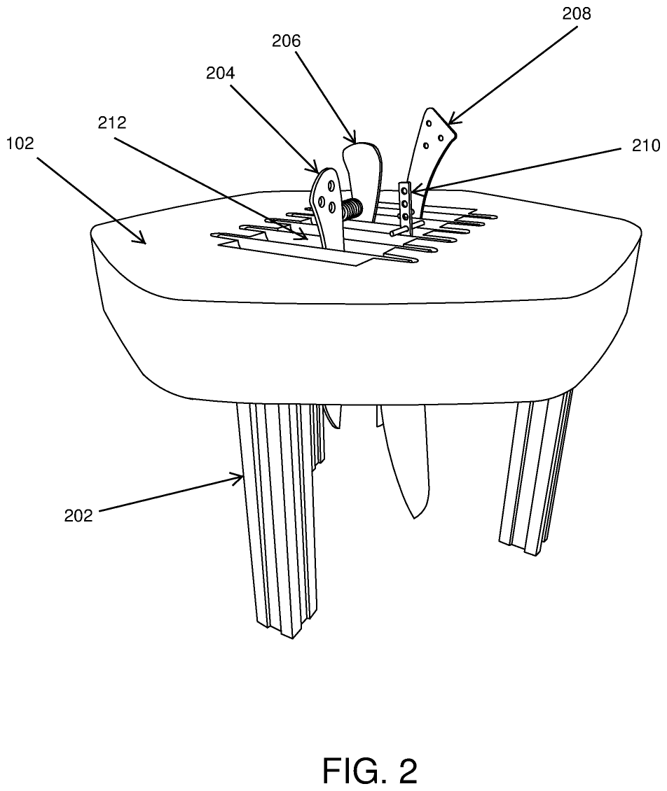

FIG. 2 is a diagram of an example baffle with support legs for a vertical kiln or vertical kiln retrofit kit in accordance with some implementations. As shown in FIG. 2, the baffle 102 can optionally include one or more legs or supports 202 to support the baffle within the kiln. FIG. 2 also shows a plurality of blades being supported by pins (208 and 210) that engage pairs of the ceramic rods, a blade being supported by a coil member (206), and a blade (204) being supported between a pair of ceramic rods 212 based on the shape of the tang of the blade turned perpendicular to the ceramic rods 212.

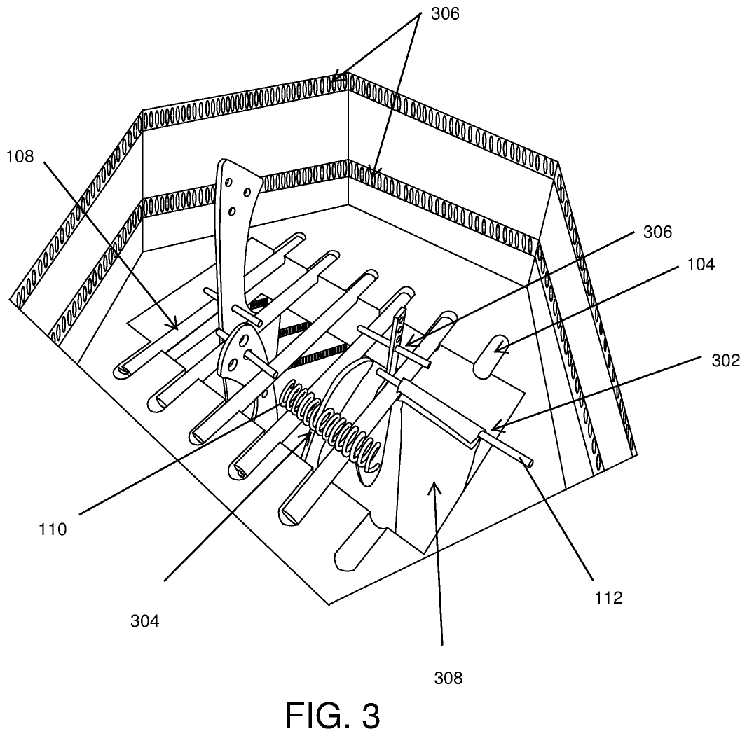

FIG. 3 is a diagram of an example vertical kiln in accordance with some implementations. As shown in FIG. 3, a central aperture 302 of a baffle can receive a blade suspended by a coil member 304 (e.g., a spring) that engages an adjacent pair of ceramic rods 108. The kiln can include one or more heating elements 305.

A blade 306 can be suspended by a pin that engages an adjacent pair of ceramic rods 108. In addition, one or more ceramic rods can be removed (as shown at empty detent 104) to accommodate an object such as the sheet metal 308 that can be suspended from a longer pin or rod 112.

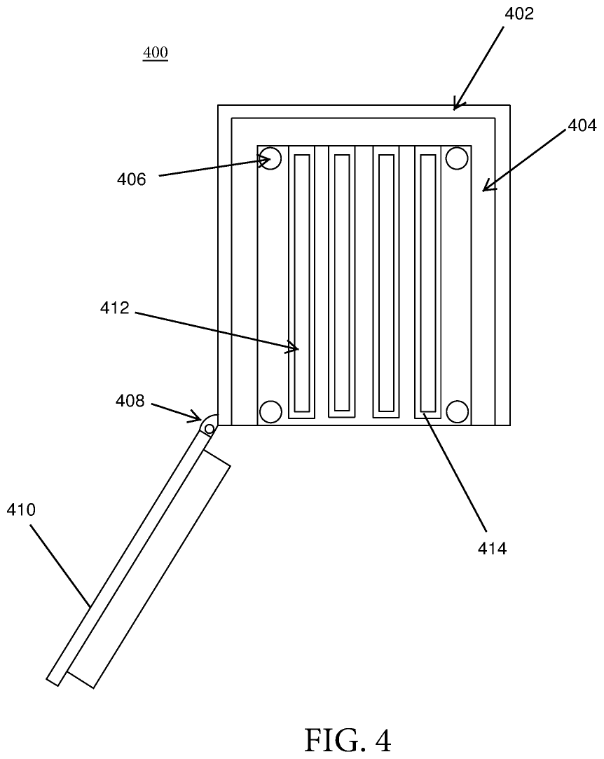

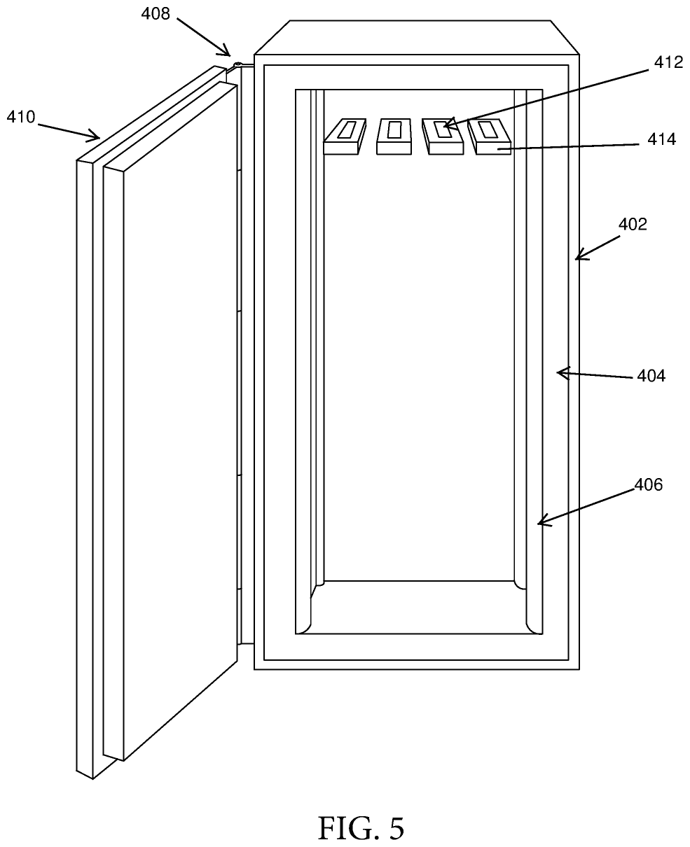

FIGS. 4 and 5 show a front loading vertical kiln 400 in accordance with some implementations. The front-loading vertical kiln 400 can include a kiln body 402 that can be formed from a solid material or a material such as expanded metal. The body 402 of the kiln can be lined with a thermal insulator material 404 such as fiber insulation, firebrick, or other suitable material. The kiln can include one or more heating elements 406 such as quartz tubes, electric coils, etc.

The front-loading vertical kiln 400 can include a door 410 that opens via a hinge 408 or other suitable mechanism. Within the front-loading vertical kiln 400 are one or more baffles 414 that each include an aperture 412 that is configured to receive a blade that is suspended vertically within the kiln via a pin, coil member, or simply based on a shape of the tang (or end) of the blade.

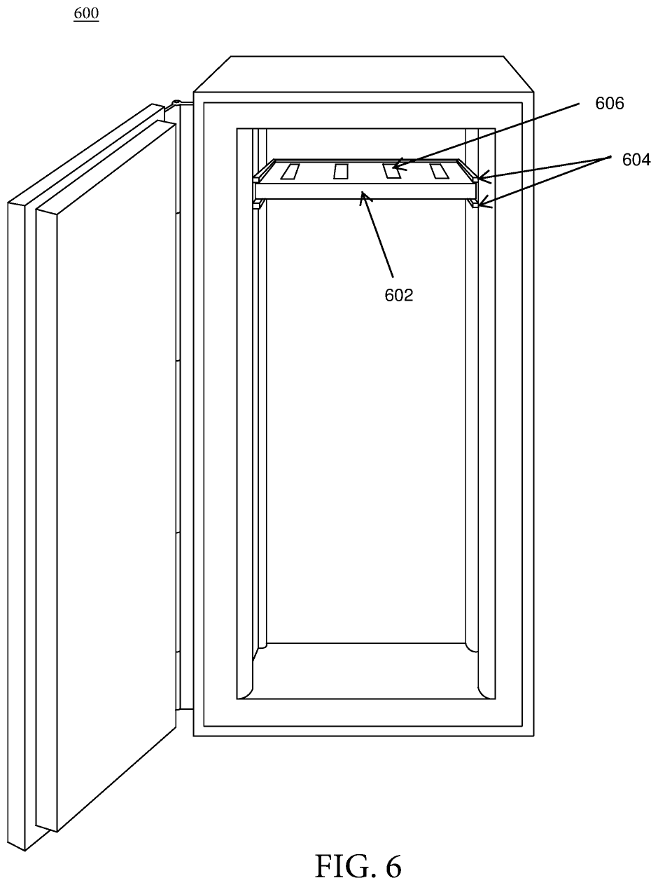

FIG. 6 is a front view of a front loading vertical kiln with removable baffle 600 in accordance with some implementations. The kiln 600 is similar to the kiln 400 shown in FIGS. 4 and 5 with the exception that the kiln 600 includes one or more removable baffles 602 supported by rails 604 within the kiln 600, and where the one or more baffles 602 include one or more apertures 606 for receiving and suspending blades vertically within the kiln.

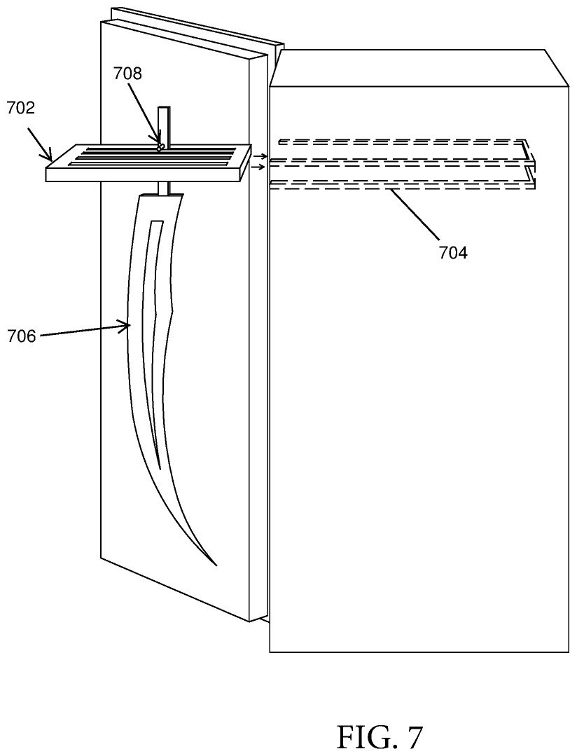

FIG. 7 is a side view of a front loading vertical kiln in accordance with some implementations. FIG. 7 shows a front-loading vertical kiln with removable baffle similar to that shown in FIG. 6. As shown in FIG. 7, a blade 706 can pass through an aperture in the baffle 702 and be suspended via a pin 708 (or coil or other member) from the baffle for heat treatment in a vertical orientation within the kiln.

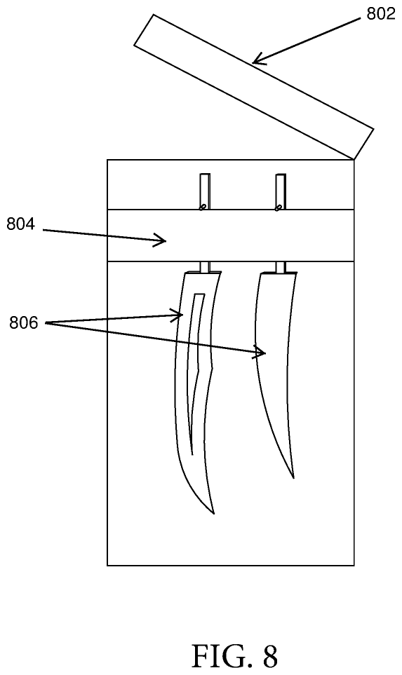

FIG. 8 is a side view of an example top loading vertical kiln that includes a lid 802, and a baffle 804 that is fixed in place within the kiln. The baffle 804 can support blades 806 (or other objects) for heat treatment.

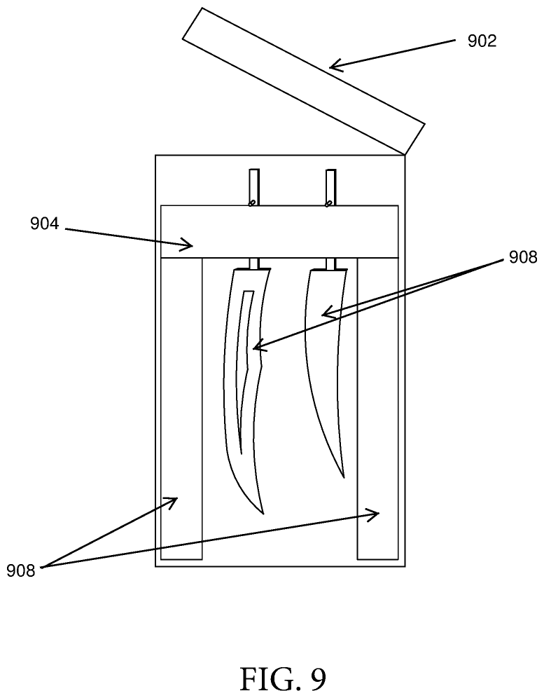

FIG. 9 is a side view of an example top loading vertical kiln retrofit kit that includes a lid 902, and retrofit kit including a removable vertical kiln baffle 904, supported by a plurality of legs 906 within the kiln. The baffle 904 can support blades 908 (or other objects) for heat treatment.

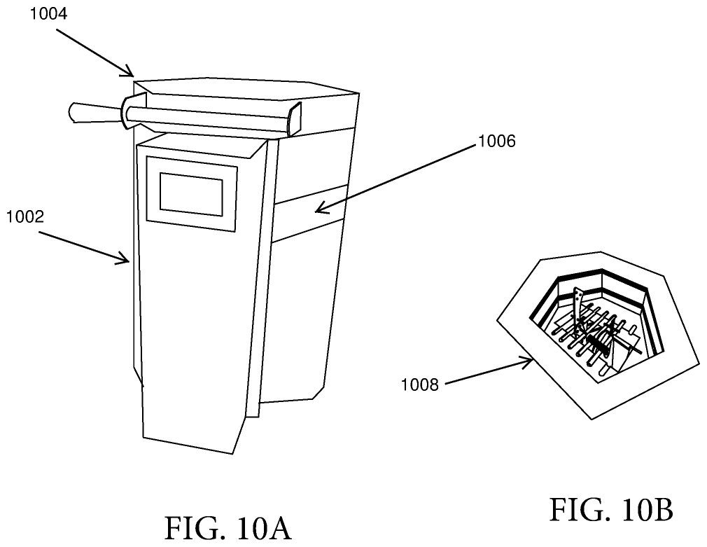

FIGS. 10A and 10B show an example top loading tabletop vertical kiln 1002 in accordance with some implementations. The top loading tabletop vertical kiln 1002 includes a lid 1004 and a baffle 1008 that is disposed within the kiln at 1006.

It is, therefore, apparent that there is provided, in accordance with the various implementations disclosed herein, top-loading vertical kilns, front-loading vertical kilns, vertical kiln systems, vertical kiln retrofit kits and accessories.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A top-loading vertical kiln comprising:
a body portion having a lid disposed on a top side of the body, wherein the lid is configured to be opened to insert items into the kiln and closed during a heat treating operation being performed in the kiln; and
a baffle having a central aperture and a plurality of rods spaced apart from each other and configured to rest in corresponding detents in a top surface of the baffle, wherein the detents include pairs of detents with a first detent of a pair being formed on a first side of the aperture and a second detent of the pair being formed on a second side of the aperture opposite the first side.

2. The top-loading vertical kiln of claim 1, further comprising a blade suspension element configured to suspend a blade between a respective pair of rods by resting across a top of the respective pair of rods.

3. The top-loading vertical kiln of claim 2, wherein the blade suspension element is a rod configured to be inserted through an aperture in the blade.

4. The top-loading vertical kiln of claim 2, wherein the rod includes an alloy rod.

5. The top-loading vertical kiln of claim 2, wherein the blade suspension element is a coil configured to mechanically engage the blade through an interference fit.

6. The top-loading vertical kiln of claim 1, wherein the baffle is removable and is configured to be supported within the kiln by a plurality of legs extending in a downward direction from the baffle opposite the top surface.

7. The top-loading vertical kiln of claim 1, wherein the rods include ceramic rods.

8. A front-loading vertical kiln comprising:
a body portion having a lid disposed on a side of the body, wherein the lid is configured to be opened to insert items into the kiln and closed during a heat treating operation being performed in the kiln; and
a baffle having a central aperture and a plurality of rods spaced apart from each other and configured to rest in corresponding detents in a top surface of the baffle, wherein the detents include pairs of detents with a first detent of a pair being formed on a first side of the aperture and a second detent of the pair being formed on a second side of the aperture opposite the first side.

9. The front-loading vertical kiln of claim 8, further comprising a blade suspension element configured to suspend a blade between a respective pair of rods by resting across a top of the respective pair of rods.

10. The front-loading vertical kiln of claim 9, wherein the blade suspension element is a rod configured to be inserted through an aperture in the blade.

11. The front-loading vertical kiln of claim 9, wherein the rod includes an alloy rod.

12. The front-loading vertical kiln of claim 9, wherein the blade suspension element is a coil configured to mechanically engage the blade through an interference fit.

13. The front-loading vertical kiln of claim 8, wherein the baffle is removable and is configured to be supported within the kiln by a plurality of legs extending in a downward direction from the baffle opposite the top surface.

14. The front-loading vertical kiln of claim 8, wherein the rods include ceramic rods.

15. A vertical hanging system kiln retrofit kit comprising:
a baffle having a central aperture and a plurality of rods spaced apart from each other and configured to rest in corresponding detents in a top surface of the baffle, wherein the detents include pairs of detents with a first detent of a pair being formed on a first side of the aperture and a second detent of the pair being formed on a second side of the aperture opposite the first side.

16. The vertical hanging system kiln retrofit kit of claim 15, further comprising a blade suspension element configured to suspend a blade between a respective pair of rods by resting across a top of the respective pair of rods.

17. The vertical hanging system kiln retrofit kit of claim 16, wherein the blade suspension element is a rod configured to be inserted through an aperture in the blade.

18. The vertical hanging system kiln retrofit kit of claim 17, wherein the rod includes an alloy rod.

19. The vertical hanging system kiln retrofit kit of claim 16, wherein the blade suspension element is a coil configured to mechanically engage the blade through an interference fit.

20. The vertical hanging system kiln retrofit kit of claim 8, wherein the baffle is removable and is configured to be supported within the kiln by a plurality of legs extending in a downward direction from the baffle opposite the top surface.
